(19) United States
(12) Patent Application Publication
(10) Pub. No.: US 2014/0143086 A1
(43) Pub. Date: May 22, 2014

(54) CUSTOMIZED RECOMMENDATIONS BASED ON CUSTOMER INFORMATION

(71) Applicant: CELLCO PARTNERSHIP D/B/A VERIZON WIRELESS, Basking Ridge, NJ (US)

(72) Inventors: Kenan Birsin, South Bound Brook, NJ (US); Michael Normant, Three Bridges, NJ (US); Kaushal K. Shah, Parsippany, NJ (US); John M. Walker, Nazareth, PA (US)

(73) Assignee: Cellco Partnership d/b/a Verizon Wireless, Basking Ridge, NJ (US)

(21) Appl. No.: 13/679,658

(22) Filed: Nov. 16, 2012

(51) Int. Cl. G06Q 30/06

(52) U.S. Cl. CPC G06Q 30/0631
USPC 705/26.7

(57) ABSTRACT

A system includes a remote computing system and a mobile device. The remote computing system stores customer information in a customer database. The customer information is associated with an account identifier, and the remote computing system generates a customized recommendation based on the customer information. The mobile device receives the customer information, presents the customized recommendation, presents potential customer interests, receives a selection of at least one of the potential customer interests, and receives an updated customized recommendation from the remote computing system based at least in part on the selected customer interest.

### BACKGROUND

Service providers spend significant effort training representatives to identify customer needs and recommend products and services according to those needs. Predicting a customer's needs often requires the representative to have a strong understanding of the customer's reasons for seeking the product or service. A customer's needs can sometimes be determined from the customer's interests, such as the customer's hobbies, profession, etc. An effective representative will understand how the customer intends to use a product or service and can recommend a particular product or service that will satisfy the customer's objectives.

### BRIEF DESCRIPTION OF THE DRAWINGS

FIG. 1 illustrates an exemplary system configured to provide product or service recommendations to mobile devices based on customer information.

FIG. 2 illustrates exemplary components of the mobile devices of FIG. 1.

FIG. 3 illustrates an exemplary user interface display that may be presented by the mobile devices of FIG. 1.

FIG. 4 illustrates exemplary customer interests that may be presented by the mobile devices of FIG. 1.

FIG. 5 illustrates exemplary customer interests and customer profiles that may be presented by the mobile devices for selection or modification of FIG. 1.

FIG. 6 illustrates exemplary customized recommendations that may be presented by the mobile devices of FIG. 1.

FIG. 7 is a flowchart of an exemplary process that may be implemented by the mobile devices of FIG. 1.

### DETAILED DESCRIPTION

An exemplary system includes a remote computing system and a mobile device. The remote computing system is configured to store customer information in a customer database. The customer information is associated with an account identifier, and the remote computing system is configured to generate a customized recommendation based at least in part on the customer information. The customized recommendation may include recommendations for particular products, services, or both. The mobile device is in communication with the remote computing system and is configured to receive the customer information associated with the account identifier, and present the customized recommendation associated with the customer information. The customer information may consider various customer interests, such as hobbies, level of education, profession, etc.

The customer's interests may change over time or a representative may learn additional information about the customer. That additional information may be relevant to future recommendations. Accordingly, the mobile device may be further configured to present a representation of potential customer interests, receive a selection of at least one of the potential customer interests and receive an updated customized recommendation from the remote computing system based at least in part on the selected customer interest. The system allows representatives to consistently recommend products or services to customers based on the customer's perceived needs based on his or her interests. Moreover, because the customer information is synchronized between the mobile device and the remote computing system, the customer does not need to repeat his or her input when talking to other representatives.

The figures illustrate an exemplary system for providing product or service recommendations to mobile devices based on customer information, and particularly, upon the customer's interests. The system may take many different forms and include multiple and/or alternate components and facilities. While an exemplary system is shown in the figures, the exemplary components illustrated in the Figures are not intended to be limiting. Indeed, additional or alternative components and/or implementations may be used. For example, while the system is generally discussed in the context of a mobile device or tablet computer, alternative approaches may include implementing the system online, such as through an ecommerce website, or through other types of hardware, such as a desktop computer located at a point of sale or call center.

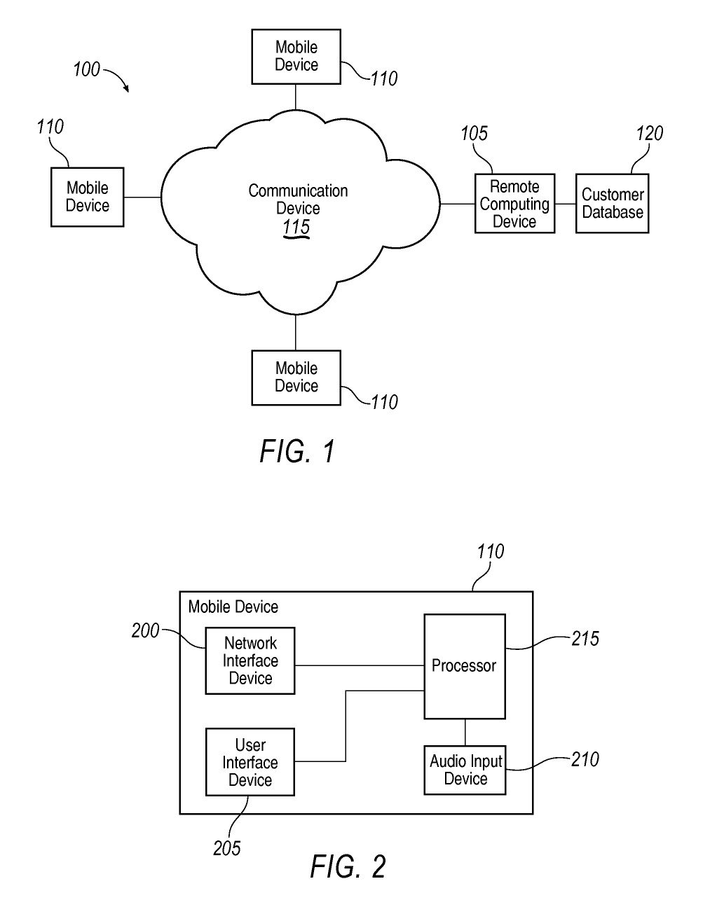

As illustrated in FIG. 1, a system 100 includes a remote computing system 105 and a plurality of mobile devices 110. Each mobile device 110 is configured to communicate with the remote computing system 105 over a communication network 115.

The remote computing system 105 may include any hardware device, such as one or more servers, configured to store customer information in a customer database 120 and provide a customized recommendation based on the customer information. Although illustrated as a single database, the information stored in the customer database 120 may be distributed among multiple databases. The customer database 120 may associate the customer information with an account identifier, and the customer information may include one or more customer profiles. Each customer profile may represent a particular customer. For instance, the customer information for a family of four may have four customer profiles associated with the account identifier. The name of each customer profile may correspond to one family member's name. The customer profile may further include information about the customer's perceived needs based on interests communicated to a representative. The customer may have told the representative about liking a particular sports team or having a particular hobby while the customer was shopping for or researching a particular product. To help the customer identify a suitable product given the customer's interests the representative may have made a note of the customer's interest in the customer profile, and the customer profile that includes the customer's interests may be stored in the customer database 120. The remote computing system 105 may be configured to query the customer database 120 for the customer information, customer profiles, or both, using, e.g., the account identifier. The remote computing system 105 may generate the customized recommendation based at least in part on the customer information stored in the customer database 120. As new customer interests or updated customer information is received, the remote computing system 105 may be configured to update the customer database 120 and generate updated customized recommendations. A complete list of customer interests may be stored in one or more databases, such as the customer database 120 or another database, accessible to the remote computing device 105.

In one exemplary implementation, the remote computing system 105 may implement a heuristic that considers the customer's interests. The heuristic may have the remote computing system 105 consult a lookup table that maps customer interests to particular products. The lookup table may map products to customer interests based on features of the product or whether other customers with similar interests have purchased the product. Thus, the heuristic may determine whether any products or services are particularly suited to one or more customer interests, and if so, include those products in the customized recommendation. The heuristic may be updated periodically to map customer interests to different products, e.g., when new products become available.

By way of example, a customer who is interested in running may appreciate recommendations for products that support that hobby. The lookup table may map the customer interest of “running” to products with features that can be used while running (e.g., products that play music, track distance using GPS, etc.) as well as accessories that make the product more conducive to use while running (sweat-proof armbands, for example). Additionally, the lookup table may recognize that many customers who enjoy running purchase the same few products and include such products in the customized recommendation. Upon recognition of “running” as a customer interest, the remote computing system 105 may consult the lookup table for products associated with “running ” The remote computing system 105 may be configured to generate the customized recommendation with the products that are associated with “running” in the lookup table.

In one possible implementation, the remote computing device 105 may be configured to identify a hierarchical relationship between two or more customer interests. Thus, subcategories may exist for each type of customer interest. For example, a customer interest acting as a “root” in the hierarchy may include “sports.” Categories of “sports” may include “football,” “baseball,” “basketball,” etc. Within each of these categories may be different organizations (NFL®, MLB®, NBA®) or team names (e.g., New York Giants® may be a subcategory under the “football” category), for example. Each level in the hierarchy may be mapped to products or services using the heuristic described above. Thus, the selection of “football” as a customer interest may generate a different customized recommendation than the selection of “baseball” as the customer interest.

The customized recommendation may include services in addition to or instead of products. For instance, customized recommendations for a customer with children who play sports may include products with video capture capability and a data plan that allows the customer to upload the videos to, e.g., a social networking website. The lookup table, therefore, may map services (e.g., the ability to upload videos) to particular customer interests (e.g., “children who play sports”).

The customer information may further include an identification of previous products the customer has purchased. Such products may be considered by the remote computing system 105 when generating the customized recommendation. For example, the customized recommendation may include an identification of one or more products previously purchased by the customer. In addition or in the alternative, the customized recommendation may intentionally exclude one or more previously purchased products. The customer information may further include an indication of products that the customer has previously declined. Previously declined products may include products that the customer has no interest in purchasing. These may include products the customer has already considered but decided against purchasing for one reason or another. The remote computing system 105 may filter declined products from future customized recommendations for that customer. The remote computing system 105 may therefore provide unique customized recommendations for each customer profile.

Each of the mobile devices 110 may be configured to present the customer information, customer profiles, representations of potential customer interests, customized recommendation, etc., to representatives at a point of sale. In one possible approach, the mobile device 100 is configured to receive an application from the remote computing system 105 over the communication network 115 using, for instance, a transfer protocol such as hypertext transfer protocol (HTTP). The mobile device 110 may receive the account identifier from, e.g., the representative or the customer. The mobile device 110 may transmit the account information to the remote computing system 105, and in return, receive the customer information and customized recommendation from the remote computing system 105. The customer information may include the customer profiles, representations of selected customer interests, and representations of potential customer interests. The mobile device 110 may be configured to present the customer information and customized recommendation to the representative. Indeed, any one or more of the following may be presented to the representative via the mobile device 110: customer information, including one or more customer profiles and customer interests; potential customer interests; a customized recommendation; previously purchased products; and previously declined products, among other information.

As the customer shares information with the representative, the customer profile may be updated in real time, using the mobile device 110, to include selected customer interests. As a result, the mobile device 110 may present updated customized recommendations that the representative can share with the customer. When the mobile device 110 receives a selection of a customer interest, or more specifically, a selection of a representation of the customer interest presented on the mobile device 100, the mobile device 110 may be configured to associate the selected customer interest to one or more of the customer profiles to generate updated customer information. The updated customer information may be transmitted to the remote computing system 105. The mobile device 110 may receive, from the remote computing system 105, an updated customized recommendation that considers the selected customer interest.

One way to receive the selection of the customer interest may be through a touch-screen display. The customer or the representative may, in one possible approach, select one or more icons representing potential customer interests. The selected customer interest may be associated with a customer profile by an additional selection. The selections made through the touch-screen display may be based on gestures performed by the user. For instance, selecting a customer interest may involve the user touching the icon displayed on the touchscreen. This may be referred to as a “touch” gesture. Associating a customer interest with a customer profile may include the user “dragging” an icon representing the customer interest to a part of the user interface display presenting the customer profile. This may be referred to as a “drag” gesture. As discussed above, each customer interest may be part of a hierarchy. Therefore, the selection of one customer interest may cause the mobile device 110 to present subcategories of the selected customer interest for an additional or alternative selection, either by voice detection (see below) or manual input using the touch-screen display.

Further or in the alternative, the mobile device 110 may be configured to receive audio signals through, e.g., a microphone to identify customer interests via voice detection. The audio signals may be from a discussion between the customer and a representative whose voices may be received at the microphone. The mobile device 110 may be configured to “listen” to the audio signals for potential customer interests. Without recording the conversation, the mobile device 110 may process the audio signals and extract words associated with customer interests. For instance, the mobile device 110 may extract the word “running,” which may be a potential customer interest, from the audio signal. The mobile device 110 may then identify “running” as a potential profile element that the representative can select and associate with the customer speaking.

Any time during or after the conversation, the mobile device 110 may prompt the customer or representative to confirm any customer interests determined from the conversation. To continue with the example above, the mobile device 110 may prompt the customer or representative to confirm that the customer has an interest in running and that the customer interest icon representing “running” should be added to the customer profile. The mobile device 110 may further prompt the customer or representative to select the customer profile to which the selected customer interest should be added.

Because the customer information is synchronized with the remote computing system 105, any mobile device 110 that receives the customer information will receive the same customized recommendations. The customer will not need to repeat customer interests when communicating with a different representative during subsequent visits, over the telephone, or online, for instance. In addition, because declined products may be excluded from the customized recommendations, the customer may not be presented with products he or she has already decided not to purchase. Of course, updated information received from the customer may result in a modification of a prior decision to decline a previous recommendation. For instance, the customer may have previously declined a product with features intended for runners. The customer may have recently taken up an interest in running, and therefore, may now wish to receive recommendations for products with such features.

The communication network 115 may be configured to facilitate communication between the mobile devices 110 and the remote computing system 105. The communication network 115 may include the Internet or another type of packet-switched network, a cellular network, a Bluetooth® network, and the like. The communication network 115 may be configured to transmit information among the mobile devices 110, between the mobile devices 110 and the remote computing system 105, or both.

FIG. 2 illustrates exemplary components of an exemplary mobile device 110. As illustrated, the mobile device 110 includes a network interface device 200, a user interface device 205, an audio input device 210, and a processor 215.

The network interface device 200 may be configured to transmit and receive information over the communication network 115. The network interface device 200 may be configured for wired or wireless communication. As information is received, the network interface device 200 may be configured to output the received information to, e.g., the processor 215 or another component of the mobile device 110. The network interface device 200 may be configured to transmit account information to the remote computing system 105 and receive the associated customer information and customized recommendation from the remote computing system 105. The network interface device 200 may transmit the customer information and customized recommendation to the processor 215. Any one or more of the following types of information may pass through the network interface device 200: customer information, which may include customer profiles and an identification of customer interests; potential customer interests; a customized recommendation; previously purchased products; and previously declined products; among other information. When the customer information is updated to include, e.g., selected customer interests, the network interface device 200 may transmit the updated customer information to the remote computing system 105 and receive an updated customized recommendation from the remote computing system 105.

The user interface device 205 may be configured to receive inputs from the user and present outputs to the user. In one possible approach, the user interface device 205 may include a touch-sensitive display screen. The user interface device 205 may receive inputs from the user when the display screen is touched with, e.g., the user's finger or a stylus. Signals generated from touching the display screen may be transmitted from the user interface device 205 to the processor 215. The user interface device 205 may be further configured to receive signals from the processor 215 and generate signals that will cause a visual representation of the customer information to be displayed on the display screen. For instance, the user interface device 205 may present customer information and the customized recommendation to the customer or the representative. Additionally, the user interface device 205 may present representations of potential customer interests to the customer or representative. The potential customer interests may represent additional interests the customer may have but are not included in the customer information.

The user interface device 205 may be configured to receive a selection of one of more of the potential customer interests. Selecting one of the potential customer interests indicates that the customer identifies with the selected interest. The user interface device 205 may transmit a signal representing the selected customer interest to the processor 215.

The audio input device 210 may include a microphone or any other device configured to receive sound. The audio input device 210 may convert the received sound into audio signals that may be transmitted to the processor 215. The audio signals may represent one or more words spoken by the customer or a representative. Some of those words may relate to potential customer interests. The audio signal representing those potential customer interests may be transmitted, by the audio input device 210, to the processor 215 so those potential customer interests may be extracted from the audio signal. Before transmitting the audio signal, the audio input device 210 may be configured to filter the received sound during the conversion of the received sound into audio signals. Example filtering may include removing background noise.

The processor 215 may be configured to receive and process various signals. The processor 215 may receive signals from the network interface device 200, the user interface device 205, and the audio input device 210. The processor 215 may process the signals received and transmit processed signals to, e.g., the network interface device 200 for transmission to the remote computing system 105 or to the user interface device 205 for presentation to the customer or representative. In one possible implementation, the processor 215 may be configured to receive a signal, from the user interface device 205, which represents a selection of a potential customer interest. The processor 215 may associate the selected customer interest with one of the customer profiles to generate updated customer information. The updated customer information may be transmitted from the processor 215 to the network interface device 200 so that it may ultimately be sent to the remote computing system 105.

Another way to select customer interests may be from the audio signal received from the audio input device 210. As mentioned above, the audio signal may represent potential customer interests based on words spoken by the customer or representative. The processor 215 may receive and process the audio signal to extract customer interests. Any customer interests identified from the audio signal may be interpreted as selected customer interests. The processor 215 may output a signal, to the user interface device 205, which indicates that a customer interest was extracted from the audio signal so, e.g., the selected customer interest may be confirmed by the customer or representative.

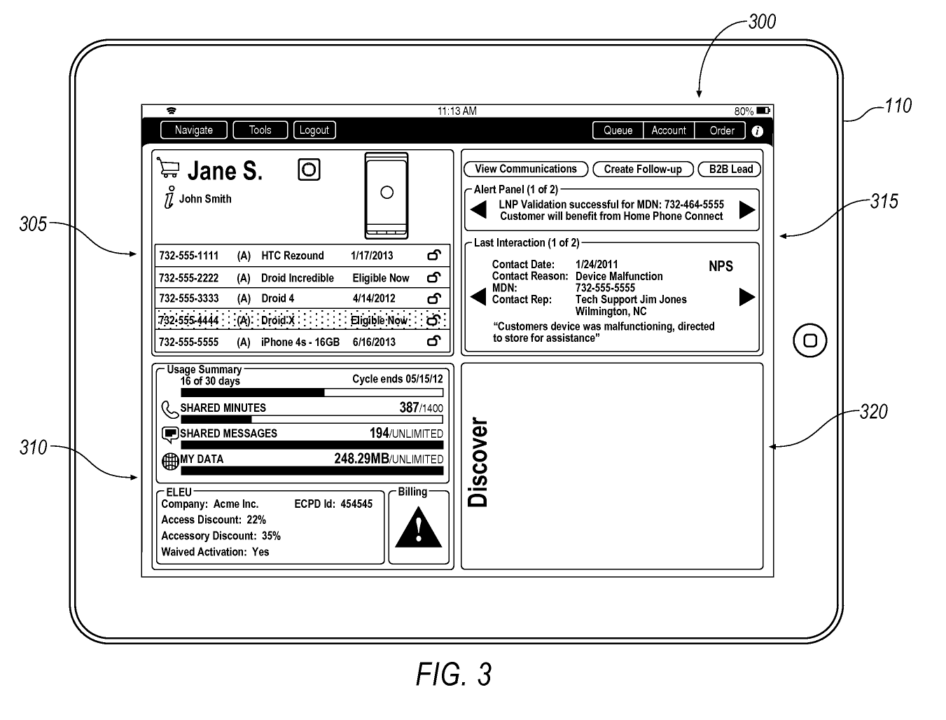

FIGS. 3-6 illustrate exemplary user interface displays that may be presented to the customer or representative during use of the mobile device 110. Because the mobile device 110 may be used at the point of sale, only certain information may be presented at the top layer. An interaction may be required to access confidential information that is used for validation. For instance, certain confidential customer information, such as the customer's address, social security number, credit card information, etc., may be excluded or require interaction by the representative to reveal.

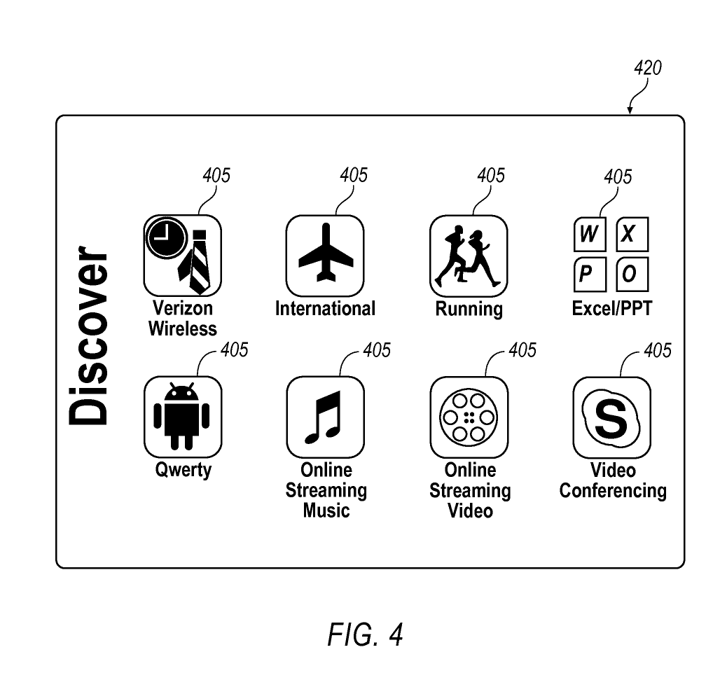

FIG. 3 illustrates an exemplary display 300 that may be presented to a representative after inputting a customer's account identifier. The exemplary display 300 includes four sections. A first section 305 presents customer information including the customer's name, account information, customer profiles associated with the account identifier, current product used by the customer, whether the customer is available for a product upgrade, etc. A second section 310 may present information related to the customer's service plan and service usage relative to the current billing cycle. A third section 315 may present history information. History information may give an overview of the customer's previous dealings to the representative. Moreover, the third section 315 may give the representative options for contacting the customer via, e.g., an electronic message such as email or text message. A fourth section 320 may be used to present previously collected customer interests the representative. More information about the fourth section 320 is discussed in greater detail below with respect to FIGS. 4-6. The information of the all four sections may be populated based upon the customer information received from the remote computing system 105. Moreover, one or more sections may be selected to view more detailed information. For instance, the user interface displays of FIGS. 4-6 may be presented after the fourth section 320 has been selected.

FIG. 4 illustrates an exemplary display 400 with selected customer interests 405. Any number of potential customer interests 405 may be presented, and each potential customer interest may be represented as an icon, text, or both. As illustrated, the icon labeled “Verizon Wireless” indicates that the customer is an employee of Verizon Wireless. The icon labeled “International” may indicate that the customer requires products that can be used internationally. The icon labeled “running” suggests that the customer enjoys running and needs a product that can be taken running The other icons shown may indicate that the customer prefers products that: allow the customer to view and edit Excel® and PowerPoint® documents, have a full “Qwerty” keyboard and implement the Android® Operating System 100, can stream music, can watch videos from a service such as Netflix® or Hulu®, and can participate in videoconferences using a service like Skype®.

The customer interests 405 presented in the display 400 would have been previously selected following, e.g., a previous conversation between a customer and representative. Alternatively, the customer may have provided the selected customer interests 405 online such as by filling out an online customer profile. The representative may show these preferences to the customer during a subsequent and ask the customer if these are still correct and whether the customer has additional or different interests that should be considered when researching a product to purchase.

The selected customer interests 405 shown in FIG. 4 may be for one particular customer profile. Other customers under the same account identifier may have selected different interests. To see customer interests from a different customer, the customer or representative may select a different customer profile from the first section 305 (see FIG. 3) or enter a different account identifier.

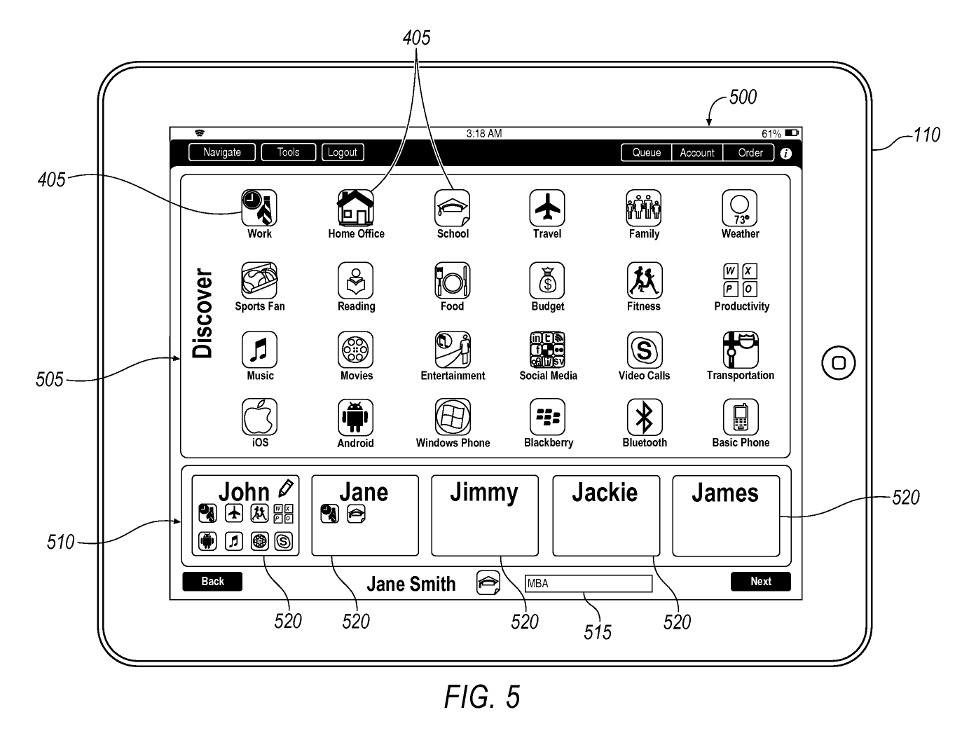

FIG. 5 illustrates an exemplary display 500 of the fourth section 320 should the customer or representative wish to select additional or new customer interests 405. The fourth section 320, expanded to substantially fill the display screen, includes a first pane 505 with the list of potential customer interests 405. As in FIG. 4, the customer interests 405 may be represented by an icon with accompanying text. A second pane 510 includes customer profiles 520 associated with the account identifier. The mobile device 110 may associate one or more customer interests 405 with one or more customer profiles. For instance, the customer or representative may select one of the icons from the first pane 505 followed by a selection of one of the customer profiles 520 from the second pane 510. Alternatively, the customer or representative may “drag” the icon representing one of the customer interests 405 from the first pane 505 to the second pane 510 associated with one of the customer profiles. Thus, the mobile device 105 may associate the customer interest 405 to a customer profile upon receipt of a “drag” gesture. In the example of FIG. 5, the customer profile 520 associated with the customer named “John” has eight customer interests 405 identified while the customer profile 520 associated with the customer named “Jane” has two customer interests 405 identified. Moreover, if one of the customer interests 405 is part of a hierarchy, selecting the icon associated with the customer interest (i.e., receiving a “touch” gesture) may cause subcategories of the selected customer interest 405 to be displayed.

The display 500 presented in FIG. 5 further includes an input field 515. When a customer interest 405 is associated with a customer profile 520, the customer or representative may enter additional information associated with the selected customer interest 405 into the input field 515. In the example of FIG. 5, the “School” icon has been selected and associated with the customer profile 520 entitled “Jane.” The customer or representative put the letters “MBA” into the input field 515 to indicate that the customer Jane received or is pursuing a Master's degree in Business Administration. This additional information may be considered by the remote computing system 105 when identifying products that may be useful to Jane.

As new customer interests 405 are associated with one or more of the profiles 520, the updated customer information may be transmitted to the remote computing system 105. The remote computing system 105 may generate an updated customized recommendation, if necessary, based on the updated customer information. The updated customized recommendation may be transmitted to the mobile device 110 where so that the updated customized recommendation can be presented to the customer or representative.

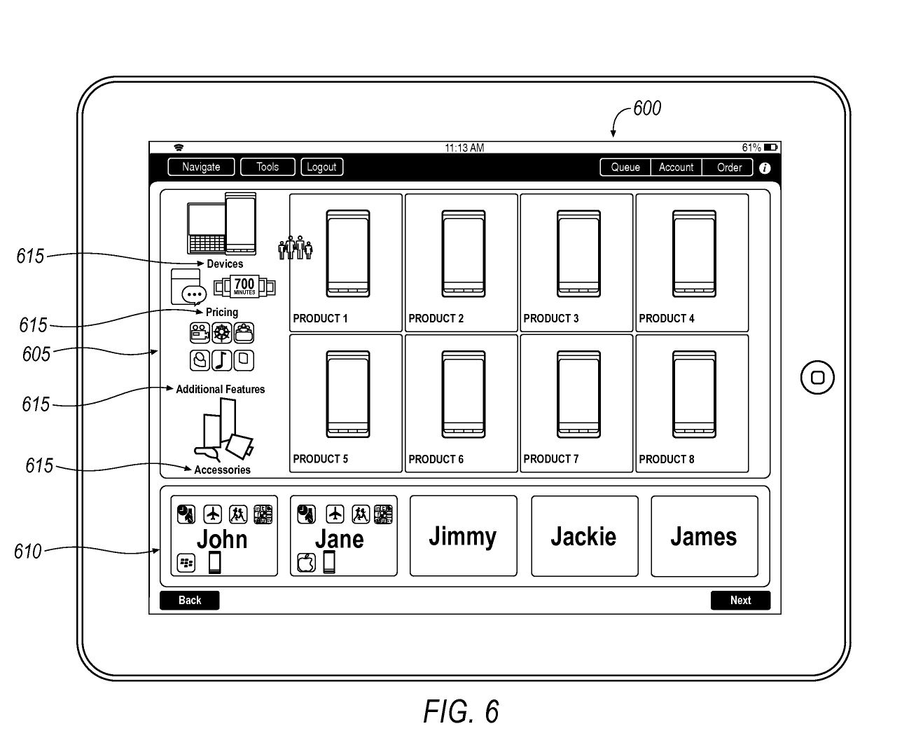

FIG. 6 illustrates an exemplary display 600 of customized recommendations that may be presented by the mobile devices 110 of FIG. 1. In this display 600, the first pane 605 may be updated to present a visual depiction of the recommended products. The second pane 610 may present the customer profiles 520. When the customer or representative selects one of the customer profiles 520, the first pane 605 may be updated to reflect the customized recommendations for the selected profile 520. The customized recommendation may include different categories 615 of products, services, or both. The category called “Devices” as shown in FIG. 6 may include products such as mobile telephones or tablet computers. The “Pricing” category may include details of recommended service plans for the customer. The “Additional Features” category may refer to recommended applications that may be used with the products in the “Devices” category. The category called “Accessories” may include recommendations of other products that complement the products in the “Devices” category. “Accessories” may include protective cases, chargers, headphones, armbands, etc.

As illustrated, the recommended products associated with the selected category are shown to the right of the categories 615 in the first pane 605. In the exemplary approach of FIG. 6, eight products are illustrated, and these products may be part of the “Devices” category. Certain recommended products may be added to a customer profile 520 if, e.g., the customer wishes to purchase the recommended product. Once added to the customer profile 520, the mobile device 110 may consider the product as “purchased.” The customer may then be billed for the selected product. In one possible implementation, the selected product may also be shipped to the customer.

If the customer has considered but ultimately decided against purchasing a particular recommended product, the customer or representative can remove the recommended product from appearing in future recommendations. For instance, the customer information, and in particular the customer profile, may be updated to reflect that a particular product was declined. When the customer information is transmitted to the remote computing system 105, the remote computing system 105 will remove any declined products before sending future recommendations for that customer profile.

It may be possible, however, for some declined products to be included in future recommendations. The customer may have declined a product with features intended for people with particular interests that the customer did not have at the time. After taking up the new interest, the customer may wish to consider those previously declined products. For example, the customer may have previously declined products intended to be used while running After taking up running as a hobby, however, the customer may wish to consider such products again.

In general, computing systems and/or devices, such as the mobile device 110 and remote computing system 105, may employ any of a number of computer operating systems, including, but by no means limited to, versions and/or varieties of the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OS X and iOS operating systems distributed by Apple Inc. of Cupertino, Calif., the BlackBerry OS distributed by Research In Motion of Waterloo, Canada, and the Android operating system developed by the Open Handset Alliance. Examples of computing devices include, without limitation, a computer workstation, a server, a desktop, notebook, laptop, or handheld computer, or some other computing system and/or device.

Computing devices generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein, such as the customer database 120, may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

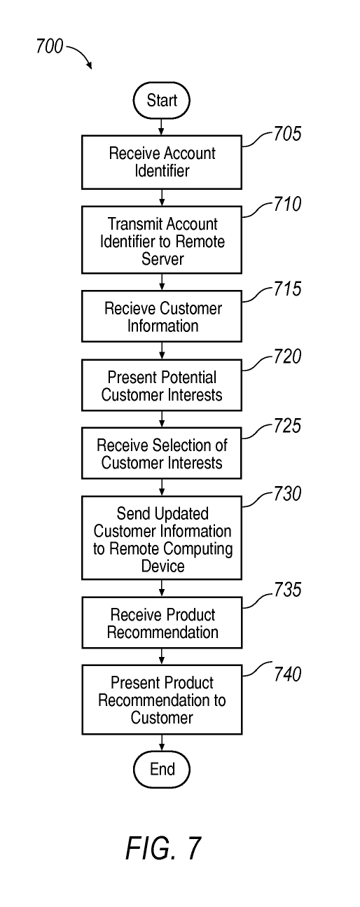

FIG. 7 is a process flow diagram of an exemplary process 700 that may be implemented by the mobile device 110. This process 700 may occur at a point of sale, such as when a customer goes to a store to research a product.

At block 705, the mobile device 110 may receive the account identifier. The account identifier may be received at the mobile device 110 through the user input device, which as described above may include a touch-sensitive display screen. Alternatively, the account identifier may be received through the audio input device 210. Either the customer or the representative may provide the account identifier to the mobile device 110.

At block 710, the mobile device 110 may transmit the account identifier to the remote computing system 105. The account identifier may be transmitted from the user interface device 205 or the audio input device 210 to the network interface device 200. For example, the user interface device 205 or audio input device 210 may transmit the account identifier to the processor 215, which may in turn forward the account identifier to the network interface device 200 with instructions to transmit the account identifier to the remote computing system 105 over the communication network 115.

At block 715, the mobile device 110 may receive customer information associated with the account identifier. Upon receiving the account identifier, the remote computing system 105 may query the customer database 120 for the customer information associated with the account identifier. The retrieved customer information may be transmitted to the mobile device 110. The customer information received at the mobile device 110 may include one or more customer profiles, customer interests, potential customer interests, customized recommendations, previously declined products, previously purchased products, and the like.

At block 720, the mobile device 110 may present potential customer interests to the customer or representative. The potential customer interests may be presented as icons, text, or both. The potential customer interests, as discussed above, may relate to products or hobbies the customer enjoys. The potential customer interests may be presented to the user via a display screen, and an example user interface display is illustrated in FIG. 4.

At block 725, the mobile device 110 may receive a selection of customer interests. The customer interests may be selected using the touch-sensitive display screen by pressing the icon associated with one of the customer interests (i.e., the “touch” gesture described above). Alternatively, one or more customer interests may be selected by saying words associated with the customer interest. The mobile device 110 may “listen” for sounds during a conversation between the customer and representative. If words associated with one or more customer interest are identified, the mobile device 110 may select the corresponding customer interest. Once selected, the mobile device 110 may associate the selected customer interest with one or more of the customer profiles. The mobile device 110 may do so automatically based on, e.g., a previous selection of a customer profile or the mobile device 110 may require the customer or representative to select the customer profile to which the customer interested should be associated. Another way to associate the customer interest to the customer profile is via the “drag” gesture discussed previously. In some circumstances, the mobile device 110 may guess and request that the customer or representative confirm the association of the customer interest to the customer profile at a later time.

At block 730, the mobile device 110 may send updated customer information to the remote computing system 105. Associating the selected customer interest to one or more of the profiles results in a change in the customer information. To keep the customer information stored on the mobile device 110 and the customer information stored in the customer database 120 synchronized, the mobile device 110 may transmit the updated customer information to the remote computing system 105, which may update the customer database 120 accordingly.

At block 735, the mobile device 110 may receive a customized recommendation from the remote computing device 105. The customized recommendation may be based, at least in part, on the customer information received at block 715 or the updated customer information generated upon the selection of the customer interest at block 725. In either circumstance, the customized recommendation received from the remote computing system 105 considers the customer information, including customer interests, stored in the customer database 120 at the time the customized recommendation is generated. The remote computing system 105, as previously discussed, may filter the customized recommendation to exclude previously declined products.

At block 740, the mobile device 110 may present the customized recommendation to the customer or representative. The customized recommendation may be broken down into various categories, as presented above with respect to FIG. 6. If a product is selected, the product may be associated with the customer profile of the customer who selected the product. The product may then be billed, and in some circumstances, shipped to the customer. If a product is declined, the customer or representative may mark the product as declined relative to the customer profile.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

1. A system comprising:
a remote computing system configured to store customer information in a customer database, wherein the customer information is associated with an account identifier, and wherein the remote computing system is configured to generate a customized recommendation based at least in part on the customer information; and
a mobile device in communication with the remote computing system and configured to:
receive the customer information associated with the account identifier,
present the customized recommendation associated with the customer information,
present potential customer interests,
receive a selection of at least one of the potential customer interests, and
receive an updated customized recommendation from the remote computing system based at least in part on the selected customer interest.

2. The system of claim 1, wherein the mobile device is configured to transmit the account identifier to the remote computing system.

3. The system of claim 1, wherein the remote computing system is configured to generate the updated customized recommendation based at least in part on the selected customer interests.

4. The system of claim 1, wherein the remote computing system is configured to query the customer database for the customer information using the account identifier.

5. The system of claim 1, wherein the customer information includes an identification of products previously purchased by a customer.

6. The system of claim 5, wherein the remote computing system is configured to include at least one product in the identification in the customized recommendation.

7. The system of claim 5, wherein the remote computing system is configured to exclude at least one product in the identification from the customized recommendation.

8. The system of claim 1, wherein the remote computing system is configured to transmit an indication of declined recommended products to the mobile device.

9. The system of claim 8, wherein the mobile device is configured to present the indication of declined recommended products.

10. The system of claim 1, wherein the account identifier is associated with a plurality of customer profiles, and wherein the remote computing system is configured to generate the customized recommendation based at least in part on one of the customer profiles.

11. The system of claim 10, wherein the mobile device is configured to associate at least one customer interest to at least one of the customer profiles to generate updated customer information.

12. The system of claim 11, wherein the mobile device is configured to transmit the updated customer information to the remote computing system, and wherein the remote computing system is configured to generate the updated customized recommendation based at least in part on the updated customer information.

13. The system of claim 1, wherein the mobile device is configured to receive an audio signal representing at least one of the potential customer interests.

14. The system of claim 13, wherein the mobile device is configured to process the audio signal to extract the selected customer interest.

15. The system of claim 1, wherein the mobile device includes a touch screen configured to receive user inputs.

16. A mobile device comprising:
a network interface device configured to transmit an account identifier and receive customer information and a customized recommendation, wherein the customer information is associated with the account identifier and wherein the customized recommendation is based at least in part on the customer information;
a user interface device configured to present the customized recommendation generated by a remote computing system and associated with the received customer information and present potential customer interests; and
a processor configured to receive a signal representing a selection of at least one of the potential customer interests and generate updated customer information that includes the selected customer interest,
wherein the network interface device is configured to transmit the updated customer information to the remote computing system and receive an updated customized recommendation from the remote computing system, wherein the updated customized recommendation is based at least in part on the selected customer interest.

17. The mobile device of claim 16, wherein the network interface device is configured to receive an indication of previously declined recommended products.

18. The mobile device of claim 17, wherein the user interface device is configured to present the indication of previously declined recommended products.

19. The mobile device of claim 16, wherein the processor is configured to associate at least one customer interest to at least one of customer profile associated with the customer information to generate updated customer information.

20. The mobile device of claim 16, further comprising an audio input device configured to generate an audio signal representing at least one of the potential customer interests.

21. The mobile device of claim 20, wherein the processor is configured to receive the audio signal from the audio input device and process the audio signal to extract the selected customer interest.

22. The mobile device of claim 16, wherein the user interface device includes a touch-sensitive display screen configured to receive user inputs.

23. A computer-readable medium tangibly embodying computer-executable instructions comprising:
transmitting an account identifier to a remote computing system;
presenting a customized recommendation received from the remote computing system, wherein the customized recommendation is based at least in part on customer information associated with the account identifier;
presenting potential customer interests via a display device;
processing a signal representing a selection of at least one of the potential customer interests;
transmitting the selected customer interest to the remote computing system; and
presenting an updated customized recommendation received from the remote computing system, wherein the updated customized recommendation is based at least in part on the selected customer interest.

24. The computer-readable medium of claim 23, further comprising associating the selected customer interest to a customer profile.

25. The computer-readable medium of claim 23, further comprising receiving an audio signal representing at least one of the potential customer interests.

26. The computer-readable medium of claim 25, further comprising processing the audio signal to extract the selected customer interest.

27. The computer-readable medium of claim 23, wherein the signal representing the selection of the customer interest is received via a touch-sensitive screen.
